(19) United States
(12) Patent Application Publication
(10) Pub. No.: US 2006/0000385 A1
(43) Pub. Date: Jan. 5, 2006

(54) Carbon black resin ground composition, carbon black resin composition, and offset printing ink using the same

(75) Inventors: Eisei Aihara, Tokyo (JP); Shinji Ueno, Tokyo (JP); Hideaki Yamazaki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Tokyo Ink Mfg. Co., Ltd., Tokyo (JP)

(21) Appl. No.: 11/166,110

(22) Filed: Jun. 27, 2005

(30) Foreign Application Priority Data
Jul. 2, 2004 (JP) 2004-196381

(51) Int. Cl. C09D 11/00

(52) U.S. Cl. 106/31.13

(57) ABSTRACT

A carbon black resin ground composition obtainable by adding a printing ink resin that is solid at room temperature to a carbon black which has not undergone oxidation treatment and has a dibutyl phthalate oil absorption amount of 60 to 105 ml/100 g, and then conducting dry grinding, as well as a carbon black resin composition and an offset printing ink obtainable using the same.

### CROSS REFERENCE TO RELATED APPLICATIONS

This Application is based upon and claims the benefit of priority from prior Japanese Application P2004-196381 filed on Jul. 2, 2004; the entire contents of which are incorporated by reference herein.

### BACKGROUND OF THE INVENTION

1. Field of the Invention

The present invention relates to a carbon black resin ground composition and a carbon black resin composition with favorable dispersibility, and to an offset printing ink with favorable ink quality and storage stability.

2. Description of the Related Art

Black ink for offset printing is typically manufactured by mixing and dispersing carbon black in a mixture of a printing ink solvent and a varnish. Offset printed material is then obtained by printing this ink onto a substrate.

In order to ensure that this offset printing ink exhibits the required ink characteristics of gloss, coloring, etc., the carbon black must be favorably dispersed within the mixture of the printing ink solvent and the varnish. However, achieving a high degree of dispersion requires considerable time, and consumes significant quantities of time and labor in the ink manufacturing process.

In order to improve on this situation, a manufacturing method has been disclosed in which carbon black and a printing ink resin that is solid at room temperature are subjected to dry grinding, and the resulting carbon black resin ground composition is then mixed and dispersed within a mixture of a printing ink solvent and a varnish, thereby forming a carbon black resin composition in which the carbon black is favorably dispersed within the mixture (see Japanese Laid-Open Publication No. 2002-322407, Japanese Laid-Open Publication No. 2002-327143, and Japanese Laid-Open Publication No. 2002-322408). However, this method requires further improvement in terms of storage stability.

### SUMMARY OF THE INVENTION

An object of the present invention is to achieve a level of ink quality, including factors such as dispersibility and optical suitability, that exceeds that obtainable using conventional offset printing inks, and achieve a level of storage stability that has been unattainable using printing inks prepared using conventional carbon black resin ground compositions obtained by dry grinding of carbon black and resins.

A first aspect of the present invention provides a carbon black resin ground composition, obtainable by adding a printing ink resin that is solid at room temperature to a carbon black which has not undergone oxidation treatment and has a dibutyl phthalate oil absorption amount of 60 to 105 ml/100 g, and subjecting the resulting mixture to dry grinding.

A second aspect of the present invention is a preferred embodiment of the first aspect, and provides a carbon black resin ground composition according to the first aspect, wherein the quantity of the printing ink resin that is solid at room temperature is within a range from 1 to 100 parts by weight per 100 parts by weight of the carbon black.

A third aspect of the present invention is another preferred embodiment of the first aspect, and provides a carbon black resin ground composition according to either the first or second aspect, wherein the printing ink resin that is solid at room temperature comprises at least one resin selected from a group consisting of rosin-modified phenol resins, rosin-modified maleic acid resins, petroleum resins, and alkyd resins.

A fourth aspect of the present invention provides a carbon black resin composition, comprising the carbon black resin ground composition according to any one of the first through third aspects, a printing ink solvent, and a varnish.

A fifth aspect of the present invention provides an offset printing ink, obtainable using the carbon black resin composition according to the fourth aspect.

### DETAILED DESCRIPTION OF EMBODIMENTS

A carbon black resin ground composition of the present invention is obtainable by adding a printing ink resin that is solid at room temperature to a carbon black which has not undergone oxidation treatment and has a dibutyl phthalate oil absorption amount of 60 to 105 ml/100 g, and then subjecting the resulting mixture to dry grinding, and as a result, the dispersibility of the carbon black is superior.

In a carbon black resin ground composition of the present invention, the quantity of the printing ink resin that is solid at room temperature is preferably within a range from 1 to 100 parts by weight per 100 parts by weight of the carbon black, as such a quantity enables the grinding process to proceed smoothly, with little danger of resin adhesion inside the dry grinder, thereby yielding even better dispersibility.

In addition, a carbon black resin ground composition of the present invention preferably uses at least one resin selected from a group consisting of rosin-modified phenol resins, rosin-modified maleic acid resins, petroleum resins, and alkyd resins as the printing ink resin that is solid at room temperature, as such compositions provide even better dispersibility and better applicability to offset printing inks.

A carbon black resin composition of the present invention uses a carbon black resin ground composition as described above, and consequently, the dispersibility of the carbon black is superior.

An offset printing ink of the present invention is obtained using an aforementioned carbon black resin composition, and consequently, the dispersibility of the carbon black is favorable, and the tinting strength and gloss are superior. In addition, the offset printing ink also exhibits excellent storage stability, and a high level of ink productivity. The manufacturing costs for the ink are also low, enabling the ink to be supplied at low cost.

<Carbon Black>

The carbon black used in the present invention has not undergone oxidation treatment, and has a DBP (dibutyl phthalate) oil absorption amount within a range from 60 to 105 ml/100 g.

The carbon black used in printing inks has usually been subjected to oxidation treatment to improve the compatibility with resins. Examples of this oxidation treatment include ozone oxidation, oxidation under a stream of high concentration oxygen, and nitric acid oxidation, and these treatments increase the cost of the carbon black. The present invention uses low cost carbon black, which has undergone none of these treatments.

Furthermore, from the viewpoints of dispersibility and stability within the vehicle (the dispersion medium), the DBP (dibutyl phthalate) oil absorption amount for the carbon black used in the present invention should fall within a range from 60 to 105 ml/100 g, and is preferably from 70 to 105 ml/100 g. In the present invention, the DBP oil absorption amount is measured in accordance with the method prescribed in JIS K 6217-4 (2001).

Examples of commercially available carbon blacks that satisfy both of the above conditions include Niteron #200LG (manufactured by Nippon Steel Chemical Carbon Co., Ltd.), BP4302 (manufactured by Cabot Specialty Chemicals Inc.), and HiBlack 20B (manufactured by Degussa AG).

There are no particular restrictions on the form of the carbon black, which may be either granules or a powder.

<Printing Ink Resin that is Solid at Room Temperature>

The printing ink resin that is solid at room temperature used in the present invention is used to maintain the characteristics of the composition as a printing ink. Specific examples of the resin include conventional room temperature-solid resins used in offset printing inks such as rosin-modified phenol resins, rosin-modified maleic acid resins, petroleum resins, and alkyd resins. Of these, rosin-modified phenol resins are preferred.

There are no particular restrictions on the weight average molecular weight of these resins, including rosin-modified phenol resins, although values within a range from 10,000 to 120,000 are preferred.

These resins can be used either alone, or in combinations of two or more different resins.

<Carbon Black Resin Ground Composition>

The carbon black resin ground composition is obtained by adding the printing ink resin that is solid at room temperature to the carbon black, and then grinding the carbon black without actually proceeding via a liquid material. During grinding, grinding media such as metal balls or the like may be used.

If grinding media are used, the force generated by the collisions of the grinding media is used to grind the carbon black. If grinding media are not used, then the frictional grinding force is used to grind the carbon black.

A dry attritor, ball mill, or vibration mill or the like can be used as the dry grinder.

The respective blend quantities of the components subjected to dry grinding preferably provide from 1 to 100 parts by weight of the printing ink resin that is solid at room temperature per 100 parts by weight of the carbon black. If the quantity of the printing ink resin that is solid at room temperature is too large relative to the quantity of carbon black, then the danger of resin adhesion inside the dry grinder tends to increase. This phenomenon is, of course, also affected by the softening point of the resin and the grinding temperature, and the optimal quantity of resin must be determined with due consideration to these conditions.

The grinding time can be set appropriately in accordance with the type of grinder being used and the desired particle size following grinding. The temperature for the dry grinding is preferably set within a range from 80 to 200° C.

The oxygen concentration inside the dry grinder can be set via the manufacturing conditions, such as the type of grinder and the grinding temperature, and the nature of the raw materials such as the carbon black and the printing ink resin that is solid at room temperature. A low oxygen concentration following completion of the dry grinding is also effective from a safety perspective in terms of preventing dust explosions.

During dry grinding, the oxygen concentration inside the dry grinder may also be controlled by streaming an inert gas such as nitrogen through the grinder.

In the dry grinding process, the surface of the carbon black is oxidized, and the carbon black can adsorb strongly to the printing ink resin that is solid at room temperature. It is thought that this causes an improvement in the dispersibility of the carbon black within the carbon black resin ground composition, meaning when an offset printing ink is produced, an improvement can be obtained in the gloss of the printed surface.

Furthermore, in order to obtain an offset printing ink with superior levels of fluidity and storage stability, the DBP oil absorption amount of the carbon black in the carbon black resin ground composition, at the time of mixing and dispersion within the mixture of the printing ink solvent and the varnish, is preferably within a range from 60 to 70 ml/100 g.

If, as a result of the dry grinding process, the DBP oil absorption amount of the carbon black within the carbon black resin ground composition of the present invention is converged to a value within the above range, then an offset printing ink with excellent fluidity and storage stability can be obtained. Accordingly, the grinding conditions and grinding method are preferably selected so that the DBP oil absorption amount of the carbon black following grinding reduces to a value of approximately 60 to 70 ml/100 g.

<Carbon Black Resin Composition>

A carbon black resin composition (base ink) of the present invention is produced by mixing and dispersing a carbon black resin ground composition within a mixture of a printing ink solvent and a varnish.

The printing ink solvent may be any solvent that is suitable for offset printing inks, and suitable examples include high boiling point petroleum-based solvents, aliphatic hydrocarbon solvents, and higher alcohol-based solvents. Solvents that contain no aromatics are also suitable.

These solvents can be used either alone, or in combinations of two or more different solvents.

The “varnish” (printing ink varnish) incorporates both a varnish resin and a varnish solvent. Examples of the varnish resin include those conventional resins that are suitable for printing inks, such as rosin-modified phenol resins, rosin-modified maleic acid resins, petroleum resins, and alkyd resins. These resins can be used either alone, or in combinations of two or more different resins. The varnish resin is preferably the same resin as that used within the carbon black resin ground composition as the printing ink resin that is solid at room temperature.

The varnish solvent can use not only the solvent used as the aforementioned printing ink solvent, but also conventional drying oils or polymer drying oils that are suitable for printing inks, such as soybean oil, tung oil, and linseed oil. These solvents can be used either alone, or in combinations of two or more different solvents.

In addition, optional printing ink additives and the like may also be added to the varnish, or the mixture of the printing ink solvent and the varnish.

The temperature during the mixing and dispersing of the carbon black resin ground composition within the mixture of the printing ink solvent and the varnish is preferably within a range from 60 to 130° C., and the mixing time is preferably within a range from 20 to 480 minutes, although these ranges are not limiting.

<Offset Printing Ink>

An offset printing ink of the present invention can be obtained by conventional methods, by appropriate addition of a mixture of a printing ink solvent and a varnish to the carbon black resin composition described above.

### EXAMPLES

As follows is a description of specifics of the present invention based on a series of examples, although the present invention is in no way limited to the examples presented below. In the following description, the units “parts” and “%” refer to “parts by weight” and “% by weight” respectively.

### Example 1

In a dry attritor were placed 70 parts of a non-oxidized carbon black (Niteron #200LG, manufactured by Nippon Steel Chemical Carbon Co., Ltd.) with a DBP oil absorption amount of 100 ml/100 g, and 11 parts of a rosin-modified phenol resin with a softening point of 160° C. and a weight average molecular weight of 80,000 (the same resin is used in subsequent examples, and is abbreviated as simply “the rosin-modified phenol resin”), and the mixture was ground at 130° C. for one hour, yielding a carbon black resin ground composition. The DBP oil absorption amount of the carbon black obtained under these grinding conditions was 67 ml/100 g.

23 parts of the carbon black resin ground composition was added to a mixture containing 50 parts of varnish (printing ink vanish) (25 parts of the rosin-modified phenol resin and 25 parts of soybean oil) and 7 parts of AF Solvent No. 7 (manufactured by Nippon Oil Corporation, this also applies below), and following gentle stirring at 120° C. for 4 hours, the mixture was further dispersed using a 3-roll mill, yielding a base ink (a carbon black resin composition).

Subsequently, 9 parts of varnish (5 parts of the rosin-modified phenol resin and 4 parts of soybean oil) and 11 parts of AF Solvent No. 7 were added to the base ink, yielding a final ink (offset printing ink).

### Example 2

In a dry attritor were placed 70 parts of a non-oxidized carbon black (BP4302, manufactured by Cabot Specialty Chemicals Inc.) with a DBP oil absorption amount of 75 ml/100 g, and 18 parts of the rosin-modified phenol resin, and the mixture was ground at 120° C. for one hour, yielding a carbon black resin ground composition. The DBP oil absorption amount of the carbon black obtained under these grinding conditions was 62 ml/100 g.

24 parts of the carbon black resin ground composition was added to a mixture containing 49 parts of varnish (25 parts of the rosin-modified phenol resin and 24 parts of soybean oil) and 7 parts of AF Solvent No. 7, and following gentle stirring at 120° C. for 4 hours, the mixture was further dispersed using a 3-roll mill, yielding a base ink (a carbon black resin composition).

Subsequently, 11 parts of varnish (6 parts of the rosin-modified phenol resin and 5 parts of soybean oil) and 9 parts of AF Solvent No. 7 were added to the base ink, yielding a final ink (offset printing ink).

### Comparative Example 1

In a dry attritor were placed 70 parts of a non-oxidized carbon black (Niteron #200IS, manufactured by Nippon Steel Chemical Carbon Co., Ltd.) with a DBP oil absorption amount of 123 ml/100 g, and 18 parts of the rosin-modified phenol resin, and the mixture was ground at 160° C. for one hour, yielding a carbon black resin ground composition. The DBP oil absorption amount of the carbon black obtained under these grinding conditions was 75 ml/100 g.

The same method as the example 2 was then used to prepare a base ink and a final ink.

### Comparative Example 2

19 parts of an oxidized carbon black (MA11, manufactured by Mitsubishi Chemical Corporation) with a DBP oil absorption amount of 64 ml/100 g, and 61 parts of varnish (31 parts of the rosin-modified phenol resin and 30 parts of soybean oil) were stirred together gently at 120° C. for 4 hours, and the mixture was then further dispersed using a 3-roll mill, yielding a base ink.

Subsequently, 12 parts of varnish (6 parts of the rosin-modified phenol resin and 6 parts of soybean oil) and 8 parts of AF Solvent No. 7 were added to the base ink, yielding a final ink.

### Comparative Example 3

In a dry attritor was placed 88 parts of an oxidized carbon black (MA11, manufactured by Mitsubishi Chemical Corporation) with a DBP oil absorption amount of 64 ml/100 g, and the carbon black was ground at 120° C. for one hour, yielding a carbon black ground product. The DBP oil absorption amount of the carbon black obtained under these grinding conditions was 61 ml/100 g.

19 parts of the carbon black ground product was added to 61 parts of varnish (31 parts of the rosin-modified phenol resin and 30 parts of soybean oil), and following gentle stirring at 120° C. for 4 hours, the mixture was further dispersed using a 3-roll mill, yielding a base ink.

Subsequently, 12 parts of varnish (6 parts of the rosin-modified phenol resin and 6 parts of soybean oil) and 8 parts of AF Solvent No. 7 were added to the base ink, yielding a final ink.

<Evaluations>

The following evaluations were conducted. The results are shown in Table 1.

(1) DBP Oil Absorption Amount

This amount was measured using the method prescribed in JIS K 6217-4 (2001).

(2) Storage Stability

Samples of each of the final inks were stored at room temperature and 70° C. for 15 hours.

Following storage at one of these temperatures, the fluidity of each ink sample was measured at room temperature using a stationary fluidity tester (manufactured by Houei Seiko Co., Ltd.), and the value was compared with the standard fluidity (1.00) of the ink obtained in the comparative example 2. A larger value indicates a more favorable storage stability.

(3) Ink Quality

(3-1) Dispersibility

A fixed weight of base ink was dispersed by passage through the rollers of a 3-roll mill, under conditions including a roller pressure of 10 bar and a temperature of 60° C. The number of passes through the rollers required to reduce the grind gauge to 7.5 μm was used as an indicator of dispersibility. A smaller value indicates a higher degree of dispersibility.

(3-2) Optical Suitability

Using a Mitsubishi commercial web offset press Lithopia BT2-80ONEO (manufactured by Mitsubishi Heavy Industries Ltd.), each final ink was printed onto coated paper. The tinting strength L* of the printed paper was measured using a fast colorimetric spectrophotometer Spectro Photo Master CMS-35SP (manufactured by Murakami Color Research Laboratory), and was compared with the value from the comparative example 2, which was used as a standard.

In a similar manner, the gloss of the printed paper was measured using a gloss meter GM-26D (manufactured by Murakami Color Research Laboratory). A larger value indicates a higher gloss level.

TABLE 1

| | Storage stability | | Ink quality | | |
|---|---|---|---|---|---|
| | Room | | Dispersi- | Tinting | |
| | temperature | 70° C. | bility | strength | Gloss |
| Example 1 | 1.0 | 1.0 | 1 | Equal | 63.4 |
| Example 2 | 1.0 | 1.0 | 1 | Equal | 67.3 |
| Comparative | 0.2 | 0.2 | 1 | Equal | 62.7 |
| example 1 | | | | | |
| Comparative | 1.0 | 1.0 | 5 | Standard | 62.7 |
| example 2 | | | | | |
| Comparative | 1.0 | 1.0 | 3 | Equal | 60.6 |
| example 3 | | | | | |

The carbon black resin ground compositions and the carbon black resin compositions according to the present invention are also useful in inks other than offset printing inks, and in other coatings and resin molded products and the like.

It is to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. A carbon black resin ground composition, obtainable by adding a printing ink resin that is solid at room temperature to a carbon black which has not undergone oxidation treatment and has a dibutyl phthalate oil absorption amount of 60 to 105 ml/100 g, and then conducting dry grinding.

2. The carbon black resin ground composition according to claim 1, wherein a quantity of the printing ink resin that is solid at room temperature is within a range from 1 to 100 parts by weight per 100 parts by weight of the carbon black.

3. The carbon black resin ground composition according to claim 1, wherein the printing ink resin that is solid at room temperature comprises at least one resin selected from a group consisting of rosin-modified phenol resins, rosin-modified maleic acid resins, petroleum resins, and alkyd resins.

4. A carbon black resin composition, comprising the carbon black resin ground composition according to claim 1, a printing ink solvent, and a varnish.

5. An offset printing ink, obtainable using the carbon black resin composition according to claim 4.
